(19) United States
(12) Patent Application Publication
(10) Pub. No.: US 2025/0289338 A1
(43) Pub. Date: Sep. 18, 2025

(54) SYSTEM AND METHOD FOR CHARGING ELECTRIC CONSTRUCTION VEHICLES

(71) Applicant: CNH Industrial America LLC, New Holland, PA (US)

(72) Inventor: Brady Lewis, Peck, KS (US)

(21) Appl. No.: 18/602,515

(22) Filed: Mar. 12, 2024

(51) Int. Cl. B60L 53/62; B60L 53/16

(52) U.S. Cl. CPC B60L 53/62; B60L 53/16; B60L 2200/40

(57) ABSTRACT

A system for charging electric construction vehicles includes first and second connectors, each configured to be electrically coupled to a different electric construction vehicle and convey electric power to the respective vehicle. Furthermore, the system includes a switching assembly adjustable between first and second settings, each setting associated with electric power being conveyed to one of the vehicles. Moreover, the system includes a computing system configured to receive an input associated with a construction operation. Additionally, the computing system is configured to create a charging schedule for which the vehicles will be charged based on the received input. Furthermore, the computing system is configured to control the operation of the switching assembly such that the vehicles are charged based on the created charging schedule.

### FIELD OF THE INVENTION

The present disclosure generally relates to electric construction vehicles and, more particularly, to systems and methods for charging electric construction vehicles.

### BACKGROUND OF THE INVENTION

Construction vehicles, such as backhoe loaders, wheel loaders, skid steer loaders, compact track loaders, and the like, are a mainstay of construction work and industry. As such, construction vehicles typically include one or more implements for carrying materials, such as gravel, sand, or dirt, around a worksite. For example, backhoe loaders include a chassis, a loader assembly coupled to the front of the chassis, and a backhoe assembly coupled to the rear of the chassis.

For many years, construction vehicles have generally relied on an internal combustion engine to power the vehicle. However, in recent years, interest in electric construction vehicles has increased. Electric construction vehicles do not include an internal combustion engine. Instead, electric construction vehicles rely on one or more electric motors powered by an energy storage device(s), such as a battery module, to power its components.

Unlike internal combustion engine powered construction vehicles, which can be quickly and easily refueled with a liquid fuel, the energy storage device(s) of an electric construction vehicle are typically charged by an intermediary electrical device, such as a docking station, which is powered by an electric power source (e.g., the power grid). However, docking stations at work sites are generally limited, particularly during the early phases of construction. Furthermore, docking stations oftentimes do not have capacity to charge all electric construction vehicles needed at a construction work site. In this respect, it can be challenging to maintain sufficient charging of all electric construction vehicles and the other electrically powered devices needed at a construction work site.

Accordingly, an improved system and method for charging electric construction vehicles would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a system for charging electric construction vehicles. The system includes a first connector configured to be electrically coupled to a first electric construction vehicle and convey electric power received from a power source to the first electric construction vehicle. Moreover, the system includes a second connector configured to be electrically coupled to a second electric construction vehicle and convey the electric power received from the power source to the second electric construction vehicle. Furthermore, the system includes a switching assembly adjustable between a first setting in which the electric power received from the power source is conveyed to the first electric construction vehicle and a second setting in which the electric power received from the power source is conveyed to the second electric construction vehicle. Moreover, the system includes a computing system communicatively coupled to the switching assembly. The computing system is configured to receive an input associated with a construction operation. Additionally, the computing system is configured to create a charging schedule for which the first electric construction vehicle and the second electric construction vehicle will be charged based on the received input. Furthermore, the computing system is configured to control an operation of the switching assembly such that the first electric construction vehicle and the second electric construction vehicle are charged based on the created charging schedule.

In another aspect, the present subject matter is directed to a method for charging electric construction vehicles. The method includes receiving, with a computing system, an input associated with a construction operation. Furthermore, the method includes creating, with the computing system, a charging schedule for which a first electric construction vehicle and a second electric construction vehicle will be charged based on the received input. Additionally, the method includes controlling, with the computing system, an operation of a switching assembly adjustable between a first setting in which electric power is conveyed to the first electric construction vehicle and a second setting in which the electric power is conveyed to the second electric construction vehicle such that the first electric construction vehicle and the second electric construction vehicle are charged based on the created charging schedule.

In a further aspect, the present subject matter is directed to a docking station for charging electric construction vehicles. The docking station includes a first charging conduit configured to be electrically coupled to a first electric construction vehicle and convey electric power received from a power source to the first electric construction vehicle. Moreover, the docking station includes a second charging conduit configured to be electrically coupled to a second electric construction vehicle and convey the electric power received from the power source to the second electric construction vehicle. Additionally, the docking station includes a first connector configured to electrically couple the first charging conduit to the first electric construction vehicle and a second connector configured to electrically couple the second charging conduit to the second electric construction vehicle. Furthermore, the docking station includes a switching assembly adjustable between a first setting in which the electric power received from the power source is conveyed to the first electric construction vehicle and a second setting in which the electric power received from the power source is conveyed to the second electric construction vehicle. Moreover, the docking station includes a computing system communicatively coupled to the switching assembly. The computing system is configured to receive an input associated with a construction operation. Additionally, the computing system is configured to create a charging schedule for which the first electric construction vehicle and the second electric construction vehicle will be charged based on the received input. Furthermore, the computing system is configured to control an operation of the switching assembly such that the first electric construction vehicle and the second electric construction vehicle are charged based on the created charging schedule.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a side view of one embodiment of an electric construction vehicle in accordance with aspects of the present subject matter;

FIG. 2 illustrates a front view of one embodiment of an electric charging port of an electric construction vehicle in accordance with aspects of the present subject matter;

FIG. 3 illustrates a perspective view of one embodiment of a docking station for charging electric construction vehicles in accordance with aspects of the present subject matter;

FIG. 4 illustrates a diagrammatic view of the docking station shown in FIG. 3 coupled to a plurality of electric construction vehicles;

FIG. 5 illustrates a schematic view of one embodiment of a system for charging electric construction vehicles in accordance with aspects of the present subject matter;

FIG. 6 illustrates a flow diagram providing one embodiment of control logic for charging electric construction vehicles in accordance with aspects of the present subject matter; and

FIG. 7 illustrates a flow diagram of one embodiment of a method for charging electric construction vehicles in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and a method for charging electric construction vehicles. As will be described below, a docking station for charging electric vehicles includes one or more charging conduits, such as first and second charging conduits, each configured to be electrically coupled to a different electric construction vehicle and convey electric power received from one or more power sources to the respective vehicle (e.g., first and second electric construction vehicles). Additionally, the docking station includes one or more connectors, such as first and second connectors, each configured to electrically couple the corresponding charging conduit (e.g., first and second charging conduits) to the respective vehicle. Furthermore, the docking station includes a switching assembly adjustable between multiple settings in which the electric power received from the power source(s) is conveyed to the vehicle associated with the setting.

Additionally, a computing system of the disclosed system is configured to create a charging schedule for which the electric construction vehicles, such as the first and second vehicles, are charged. In this respect, the computing system may be configured to receive an input associated with the construction operation, such as an input associated with one or more construction tasks to be performed by each of the electric construction vehicles electrically coupled to the charging conduits of the docking station. Then, the computing system is configured to create the charging schedule based on the received input. For example, in several embodiments, the computing system may be configured to determine the current charged levels of each energy storage device (e.g., battery) of the electric construction vehicles based on data received from one or more charging capacity sensors. Then, the computing system may be configured to determine the required charged levels of the energy storage devices based on the expected energy consumption during performance of the construction tasks and determine the start times of the construction tasks for each vehicle. In this respect, the computing system may be configured to create the charging schedule such that each vehicle is charged from the current charged level to the required charged level prior to the start time of the construction task for the respective vehicle. Thereafter, the computing system is configured to control the operation of the switching assembly such that the electric construction vehicles are charged based on the created charging schedule.

Using a charging schedule created based on the construction operation to charge electric construction vehicles needed at a construction work site improves the construction operation. Specifically, docking stations at construction work sites are generally limited, particularly during the early phases of construction, and docking stations often do not have capacity to simultaneously charge all electric construction vehicles needed at a construction work site. The present system and method create and utilize a charging schedule based on the construction operation, such as the individual construction tasks forming the construction operation to be performed, the expected energy consumption of the electric construction vehicles, and/or the like, to automate charging of the electric construction vehicles in terms of when they are needed, how much they need to be charged, and/or the like. As such, it is more efficient to maintain sufficient charging of electric construction vehicles needed at the construction work site.

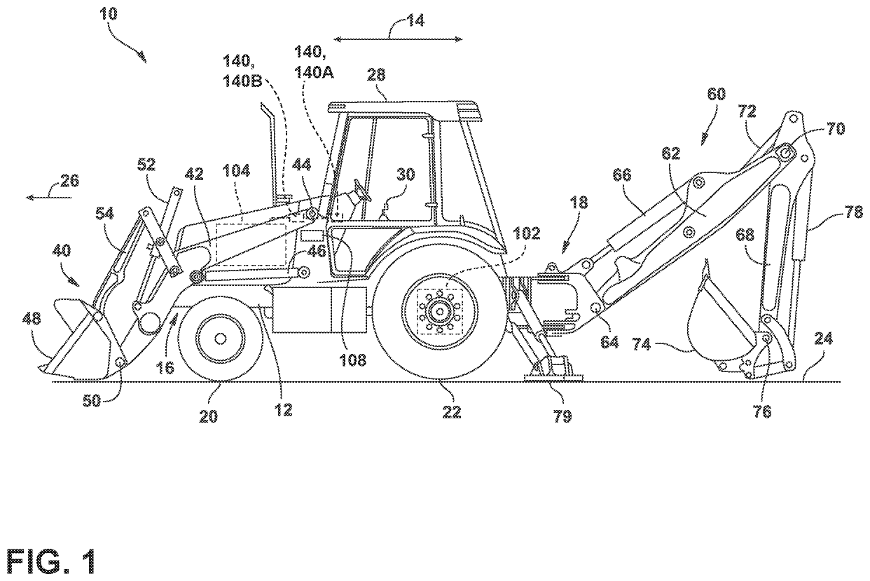

Referring now to the drawings, FIG. 1 illustrates a side view of one embodiment of an electric construction vehicle 10 in accordance with aspects of the present subject matter. As shown, the electric construction vehicle 10 is configured as an electric backhoe loader (also often referred to as a “tractor-loader-backhoe” (TLB) or a “loader backhoe”). However, in other embodiments, the electric construction vehicle 10 may be configured as any other suitable type of electric work vehicle, such as another type of electric construction vehicle (e.g., a wheel loader, a skid-steer loader, a bulldozer, etc.), an electric agricultural vehicle (e.g., a tractor), and/or the like.

As shown in FIG. 1, the electric construction vehicle 10 includes a chassis or frame 12 extending in a longitudinal direction (indicated by arrow 14 in FIG. 1) of the electric construction vehicle 10 between a forward end 16 of the frame 12 and an aft end 18 of the frame 12. In general, the chassis or frame 12 may be configured to support or couple to a plurality of components. For example, a pair of steerable front traction devices (e.g., front wheels 20 (one of which is shown)) and a pair of driven rear traction devices (e.g., rear wheels 22 (one of which is shown)) may be coupled to the frame 12. The wheels 20, 22 may support the electric construction vehicle 10 relative to a ground surface 24 and move the electric construction vehicle 10 along the ground surface 24 in a direction of travel, such as a forward direction of travel (indicated by arrow 26 in FIG. 1). However, in alternative embodiments, the front wheels 20 may be driven in addition to or in lieu of the rear wheels 22. Moreover, in other embodiments, the front and/or rear traction devices may be configured as track assemblies (not shown). Additionally, an operator's cab 28 may be supported by a portion of the frame 12 positioned between the forward and aft ends 16, 18 of the frame 12, and may house one or more operator control devices 30 (e.g., a joystick(s), a lever(s), and/or the like) for permitting an operator to control the operation of the electric construction vehicle 10.

The electric construction vehicle 10 also includes a pair of work implement assemblies positioned at the opposed ends 16, 18 of the frame 12. Specifically, in the illustrated embodiment, the electric construction vehicle 10 includes a loader assembly 40 supported by or relative the frame 12 at or adjacent to its forward end 16. As shown in FIG. 1, the loader assembly 40 includes a loader arm 42 pivotably coupled or supported relative to the frame 12 at a loader arm pivot point 44, and a loader lift cylinder 46 secured between the loader arm 42 and the frame 12. In such an embodiment, extension/retraction of the loader lift cylinder 46 may result in the loader arm 42 pivoting upwards/downwards about its respective pivot point 44, thereby allowing the positioning of the loader arm 42 relative to both the frame 12 and the ground surface 24 to be adjusted, as desired. Moreover, as shown in FIG. 1, the loader assembly 40 further includes a first work implement 48, such as a loader bucket, coupled to the loader arm 42 at an implement pivot point 50, and a first implement tilt cylinder 52 secured between the work implement 48 (e.g., via a linkage(s) 54) and a portion of the loader arm 42. As such, extension/retraction of the first implement tilt cylinder 52 may result in the first work implement 48 pivoting upwards/downwards relative to the loader arm 42 about its respective pivot point 50, thereby permitting the tilt angle or orientation of the implement 48 to be adjusted, as desired. Thus, by controlling the operation of the lift and tilt cylinders 46, 52 of the loader assembly 40, the vertical positioning and orientation of the first work implement 48 may be adjusted to allow for the execution of one or more operations, such as one or more material-moving operations.

Additionally, in the illustrated embodiment, the electric construction vehicle 10 includes a backhoe assembly 60 supported by or relative to the frame 12 at or adjacent to its aft end 18. As shown in FIG. 1, the backhoe assembly 60 includes a boom 62 pivotably coupled or supported relative to the frame 12 at a boom pivot point 64, and a boom lift cylinder 66 secured between the boom 62 and the frame 12. In such an embodiment, extension/retraction of the boom cylinder 66 may result in the boom 62 pivoting upwards/downwards about its respective pivot point 64, thereby allowing the positioning of the boom 62 relative to both the frame 12 and the ground surface 24 to be adjusted, as desired. The backhoe assembly 60 also includes a dipper arm 68 coupled to the boom 62 at a dipper pivot point 70, and a dipper cylinder 72 secured between the dipper arm 68 and the boom 62. In such an embodiment, extension/retraction of the dipper cylinder 72 may result in the dipper arm 68 pivoting upwards/downwards about its respective pivot point 70 relative to the boom 62. Moreover, as shown in FIG. 1, the backhoe assembly 60 further includes a second work implement 74, such as a dipper bucket, coupled to the dipper arm 68 at an implement pivot point 76, and a second implement tilt cylinder 78 secured between the work implement 74 and a portion of the dipper arm 68. As such, extension/retraction of the second implement tilt cylinder 78 may result in the second work implement 74 pivoting upwards/downwards relative to the dipper arm 68 about its respective pivot point 76, thereby permitting the tilt angle or orientation of the implement 74 to be adjusted, as desired. Thus, by controlling the operation of the various cylinders 66, 72, 78 of the backhoe assembly 60, the vertical positioning and orientation of the second work implement 74 may be adjusted to allow for the execution of one or more operations, such as one or more material excavation operations.

As shown in FIG. 1, the electric construction vehicle 10 may also include a pair of stabilizer legs 79 (one of which is shown) positioned at or adjacent to the aft end 18 of the frame 12. The stabilizer legs 79 may be configured to support the weight of the electric construction vehicle 10 and/or otherwise stabilize the electric construction vehicle 10 during the performance of a backhoe-related operation. For instance, the stabilizer legs 79 may be pivotably coupled to the frame 12 to allow the legs 79 to be moved or pivoted (e.g., via the operation of an associated stabilizer leg cylinder) between a lowered position, at which the legs 79 contact the ground surface 24, and a raised position, at which the legs 79 are lifted off the ground surface 24 to allow movement of the electric construction vehicle 10 (e.g., in the forward direction of travel 26). In addition to lowering the stabilizer legs 79, the loader assembly 40 may also be lowered during the performance of a backhoe-related operation such that the first work implement 48 contacts the ground, thereby providing a point-of-contact to stabilize the front end 16 of the frame 12.

Furthermore, the electric construction vehicle 10 includes one or more electric motors 102 supported on the frame 12. In general, the electric motor(s) 102 is configured to drive one or more of the traction devices of the electric construction vehicle 10 to propel the vehicle 10 in the direction of the travel (e.g., in the forward direction of travel 26). For example, in the illustrated embodiment, a pair of electric motors 102 (one of which is shown) are coupled to and configured to rotationally drive the rear wheels 22. However, in alternative embodiments, the electric construction vehicle 10 may include any other suitable number of electric motors 102 (e.g., a single electric motor 102 or three or more electric motors 102). Moreover, in other embodiments, the electric motor(s) 102 may be configured to drive any other suitable traction device(s) of the vehicle 10 (e.g., the front wheels 20 in lieu or in addition to the rear wheels 22).

Additionally, the electric construction vehicle 10 includes one or more energy storage device(s) 104 supported on the frame 12. In general, the energy storage device(s) 104 is configured to supply electric energy to the electric motor(s) 102 to drive the traction device(s) of the electric construction vehicle 10. In the illustrated embodiment, the electric construction vehicle 10 includes a single energy storage device 104. However, in alternative embodiments, the electric construction vehicle 10 may include any other suitable number of energy storage device(s) 104, such as two or more energy storage devices 104. Moreover, the energy storage device(s) 104 may be configured as any suitable electro-chemical device(s) for storing electric energy. For example, in some embodiments, the energy storage device(s) 104 may be configured as a lithium-ion battery module(s) having any suitable number of batteries or cells. However, in alternative embodiments, the energy storage device(s) 104 may be configured as a nickel metal hydride battery module(s), a lead acid battery module(s), and/or the like.

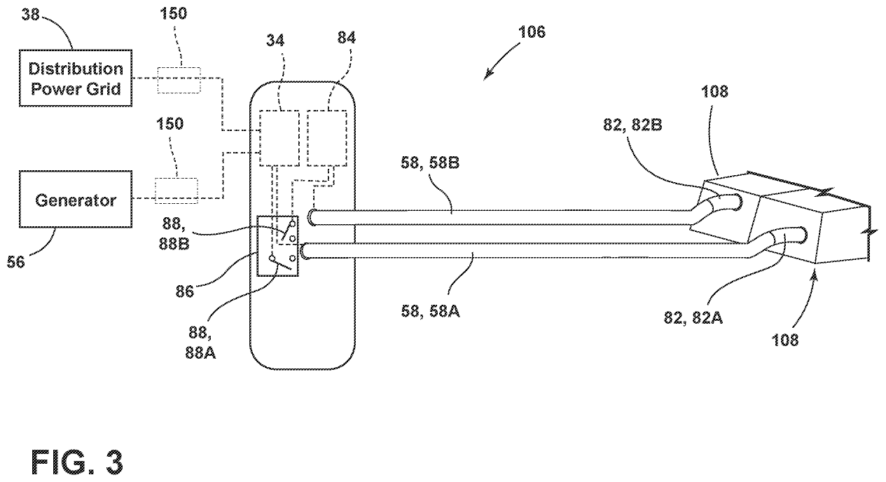

In addition, the electric construction vehicle 10 includes an electric charging port 108. In general, the charging port 108 is configured to receive electric power from an electrical charging source, such as a docking station 106 (FIG. 3), which will be described in more detail below. The electric power received by the charging port 108 can be used to charge the energy storage device(s) 104. In this respect, the charging port 108 is an interface between the docking station 106 (FIG. 3) and the energy storage device(s) 104. In the illustrated embodiment, the electric construction vehicle 10 includes a single charging port 108 located adjacent to the cab 28 to provide the operator with easy access to the charging port 108. However, in alternative embodiments, the electric construction vehicle 10 may include any other suitable number of charging ports 108 and/or the charging port(s) 108 may be located at any other suitable location(s) on the vehicle 10.

The configuration of the electric construction vehicle 10 described above and shown in FIG. 1 is provided only to place the present subject matter in an exemplary field of use. Thus, the present subject matter may be readily adaptable to any manner of electric vehicle configuration.

Furthermore, the electric construction vehicle 10 may include one or more charging capacity sensors 140, such as a first charging capacity sensor 140A and a second charging capacity sensor 140B, coupled thereto or supported thereon. In general, the charging capacity sensor(s) 140 is configured to generate data of a current charged level of the electric construction vehicle 10. As will be described below, the data generated by the charging capacity sensor(s) 140 is, in turn, subsequently used to determine the current charged level of the electric construction vehicle 10. For example, the first charging capacity sensor 140A is used to determine the current charged level of the first electric construction vehicle 10A and the second charging capacity sensor 140B is used to determine the current charged level of the second electric construction vehicle 10B.

In general, the charging capacity sensor(s) 140 may correspond to any suitable sensing device(s) configured to generate data indicative of the current charged level of the electric construction vehicle 10. For example, in one embodiment, the charging capacity sensor(s) 140 may correspond to a voltmeter(s). However, in alternative embodiments, the charging capacity sensor(s) 140 may correspond to any other suitable sensing device(s) such as an ammeter(s), a power consumption sensor(s), and/or the like.

Moreover, the electric construction vehicle 10 may include any number of charging capacity sensors 140 coupled thereto or supported thereon and configured to generate data indicative of the current charged level of the electric construction vehicle 10. In this respect, FIG. 1 illustrates an example location for mounting the charging capacity sensor(s) 140 for generating data indicative of the current charged level of the electric construction vehicle 10. For example, the charging capacity sensor(s) 140 may be electrically coupled between the electric charging port 108 and the energy storage device(s) 104 of the electric construction vehicle 10.

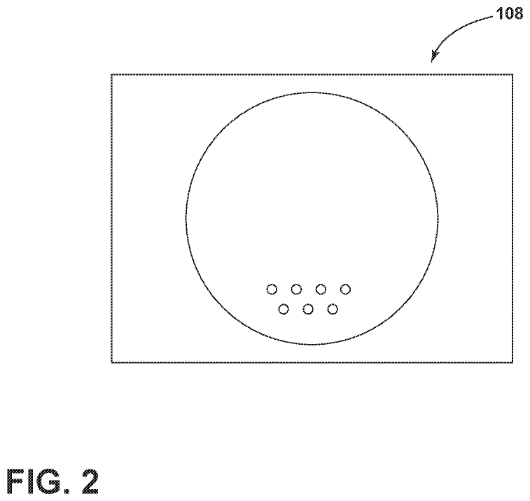

Referring now to FIG. 2, a front view of one embodiment of the electric charging port 108 of the electric construction vehicle 10 is illustrated in accordance with aspects of the present subject matter. In general, the charging port 108 is configured to receive electric power from the docking station 106 (FIG. 3). As such, the charging port 108 forms part of a mechanical interface that allows the electric construction vehicle 10 to receive electric power from the docking station 106 (FIG. 3). In the illustrated embodiment, the charging port 108 is configured as a male or female electrical receptacle provided on the electric construction vehicle 10. However, in alternative embodiments, the charging port 108 may be configured as any other suitable device for coupling an electrical charging source, such as an electric power cord or cable extending outward from the electric construction vehicle 10.

For purposes of clarity, the electric construction vehicle 10 and the associated charging system and method will be described herein in the context of having a single electric charging port 108. However, the electric construction vehicle 10 may have any suitable number of charging ports 108. For example, in one embodiment, the electric construction vehicle 10 may include multiple electric charging ports 108 to allow the electric construction vehicle 10 to receive electric power from multiple electric charging sources, if available.

The configuration of the electric construction vehicle 10 described above and shown in FIG. 2 is provided only to place the present subject matter in an exemplary field of use. Thus, the present subject matter may be readily adaptable to any manner of electric vehicle configuration.

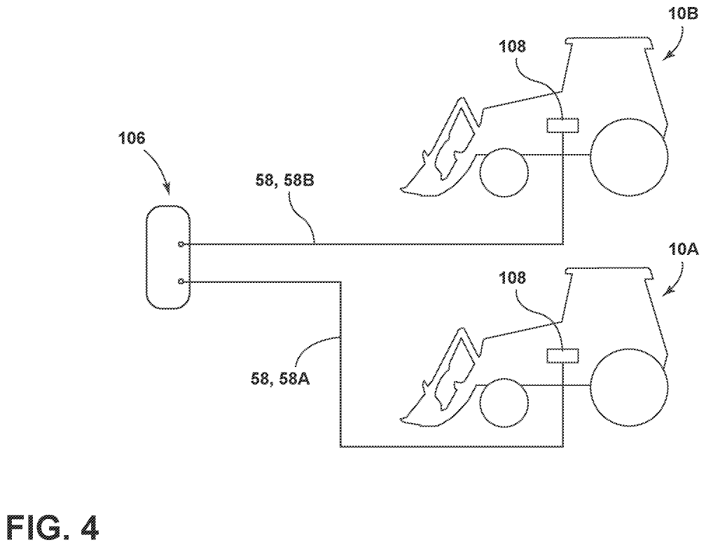

Referring now to FIGS. 3 and 4, differing views of one embodiment of a docking station 106 for charging one or more electric construction vehicles 10 are illustrated in accordance with aspects of the present subject matter. In particular, FIG. 3 illustrates a perspective view of the docking station 106. FIG. 4 illustrates a diagrammatic view of the docking station 106 shown in FIG. 3 coupled to a plurality of electric construction vehicles 10.

As shown in FIGS. 3 and 4, the docking station 106 includes an electric power converter 34 supported by a docking station frame or housing 36. The electric power converter 34 may be electrically coupled (e.g., via one or more electrical conduits) to one or more power sources and configured to convert electric power received from the power source(s) into usable electric power such as by adjusting the current type (e.g., alternating current to direct current, direct current to alternating current) of the received electric power. As shown in FIGS. 3 and 4, the electric power converter 34 is electrically coupled to and configured to receive electric power from a distribution power grid 38 and a generator 56 (e.g., powered by an internal combustion engine). However, it should be appreciated that the electric power converter 34 may be electrically coupled to and configured to receive electric power from any other suitable power source(s), such as a fuel cell(s), battery cart(s), and/or the like.

Moreover, one or more power source sensors 150 may be associated with/coupled to each of the power sources, such as the distribution power grid 38 and/or the generator. In general, the power source sensor(s) 150 is configured to generate data indicative of a quantity of the electric power received from the power source(s). As will be described below, the data generated by the power source sensor(s) 150 is, in turn, subsequently used to create a charging schedule for charging one or more electric construction vehicles.

In general, the power source sensor(s) 150 may correspond to any suitable sensing device(s) configured to generate data indicative of the quantity of the electric power received from the power source(s). For example, in one embodiment, the power source sensor(s) 150 may correspond to a current transformer (“CT”). However, in alternative embodiments, the power source sensor(s) 150 may correspond to any other suitable sensing device(s) such as a power transformer (“PT”) and/or the like.

Moreover, the any number of power source sensor(s) 150 may associated with/coupled to the power source(s) and configured to generate data indicative of the quantity of the electric power received from the power source(s). In this respect, FIG. 3 illustrates an example location for mounting the power source sensor(s) 150 for generating data indicative of the quantity of the electric power received from the power source(s). For example, the power source sensor(s) 150 may be electrically coupled between the distribution power grid 38 and the docking station 106 and/or the generator 56 and the docking station 106.

Additionally, the docking station 106 may include one or more charging conduits 58, such as a flexible electrical cable(s). The charging conduit(s) 58 is configured to convey the electric power received from the power source(s) to one or more electric construction vehicles 10 to charge the energy storage device(s) 104 of the electric construction vehicle(s) 10. In this respect, the charging conduit(s) 58 may be electrically coupled to the electric power converter 34 and configured to receive the usable electric power from the electric power converter 34 and convey the usable electric power to the electric construction vehicle(s) 10. For example, as shown in FIG. 4, the docking station 106 includes a first charging conduit 58A and a second charging conduit 58B electrically coupled to the electric power converter 34. The first charging conduit 58 is configured to convey the electric power received from the power source(s) to a first electric construction vehicle 10A and the second charging conduit 58B is configured to convey the electric power received from the power source(s) to a second electric construction vehicle 10B. However, it should be appreciated that the docking station 106 may include any suitable number of charging conduits 58. Furthermore, each charging conduit 58 may be configured to convey electric power received to any number of electric construction vehicles 10 and/or other kind of electric work vehicles.

Furthermore, the docking station 106 includes one or more connectors 82. The connector(s) 82 may be configured to electrically couple the charging conduit(s) 58 to the charging port(s) 108 of the electric construction vehicle(s) 10. For example, as shown in FIG. 4, the docking station 106 may include a first connector 82A configured to electrically couple the first charging conduit 58A to the charging port 108 of the first electric construction vehicle 10A and a second connector 82B configured to electrically couple the second charging conduit 58B to the charging port 108 of the second electric construction vehicle 10B. The connector(s) 82 may be configured as an SAE J1772 connector(s) or as an SAE J3400 connector(s). However, it should be appreciated that the connector(s) 82 may be configured as any suitable connector(s) for electrically coupling the charging conduit(s) 58 to the charging port(s) 108 of the electric construction vehicle(s) 10, such as a CCS connector(s) and/or the like. Alternatively, in some embodiments, it should be appreciated that the connector(s) 82 and the charging conduit(s) 58 may be included as part of the electric construction vehicle(s) 10. In this respect, the connector(s) 82 may be configured to electrically couple the charging conduit(s) 58 to the docking station 106, such as to receptacles/outlets on the docking station 106.

Moreover, the docking station 106 may include a regulator 84 supported by the docking station housing 36. The regulator 84 may be electrically coupled to the power source(s) and configured to adjust the quantity of the electrical power, such as the voltage, current, and/or the like, conveyed by the charging conduit(s) 58 to the electric construction vehicle(s) 10. For example, the regulator 84 may be a voltage regulator configured to adjust the voltage level. However, the regulator 84 may be any other suitable regulator configured to adjust the quantity of the electrical power. For example, the regulator 94 may be a current-mode voltage regulator configured to adjust the current level and/or the like. As will be described below, the operation of the regulator 84 may be controlled by one or more computing systems.

Furthermore, the docking station 106 includes a switching assembly 86. The switching assembly 86 may be adjustable between multiple settings, each setting being associated with the electric power received from the power source(s) being conveyed to one of the electric construction vehicles 10. For example, the switching assembly 86 may be adjustable between a first setting in which the electric power received from the power source(s) is conveyed to the first electric construction vehicle 10A, and a second setting in which the electric power received from the power source(s) is conveyed to the second electric construction vehicle 10B. In this respect, when the switching assembly 86 is adjusted to the first setting, only the first electric construction vehicle 10A is charged. Likewise, when the switching assembly 86 is adjusted to the second setting, only the second electric construction vehicle is charged 10B. As will be described below, the operation of the switching assembly 86 may be controlled by one or more computing systems.

Moreover, the switching assembly 86 may include a plurality of switches 88, each switch being associated with one of the settings. For example, the switching assembly 86 may include a first switch 88A associated with the first setting and a second switch 88B associated with the second setting. Each switch 88 may be configured as an electronic switch, such as a bipolar transistor. However, it should be appreciated that each switch 88 may configured as any other suitable kind of electronic switch.

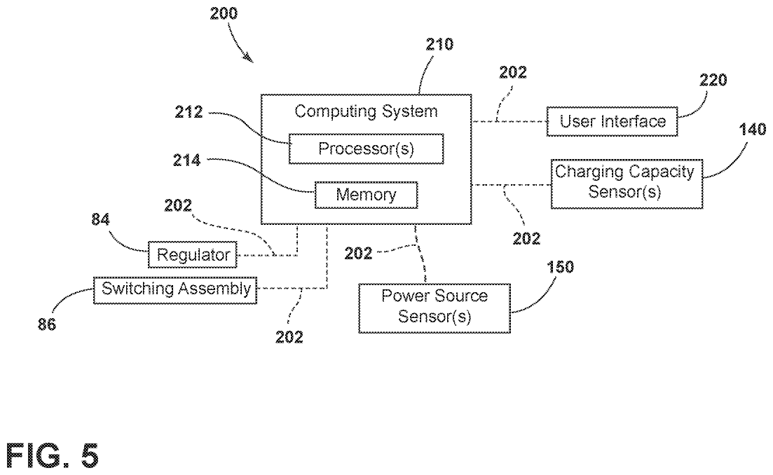

Referring now to FIG. 5, a schematic view of one embodiment of a system 200 for charging electric construction vehicles is illustrated in accordance with aspects of the present subject matter. In general, the system 200 will be described herein with reference to the electric construction vehicle 10 described above with reference to FIGS. 1 and 2 and the docking station 106 described above with reference to FIGS. 3 and 4. However, it should be appreciated by those of ordinary skill in the art that the disclosed system 200 may generally be utilized with electric construction vehicles having any other suitable vehicle configuration and/or docking stations have any other suitable docking station configuration.

Moreover, the system 200 includes a computing system 210 communicatively coupled to one or more components of the electric construction vehicle(s) 10, the docking station 106, and/or the system 200 to allow the operation of such components to be electronically or automatically controlled by the computing system 210. For instance, the computing system 210 may be communicatively coupled to the charging capacity sensor(s) 140 via a communicative link 202. As such, the computing system 210 may be configured to receive data from the charging capacity sensor(s) 140 that is indicative of the current charged level of the electric construction vehicle(s) 10. Moreover, the computing system 210 may be communicatively coupled to the power source sensor(s) 150 via the communicative link 202. As such, the computing system 210 may be configured to receive data from the power source sensor(s) 150 indicative of the quantity of the electric power received from the power source(s). Furthermore, the computing system 210 may be communicatively coupled to the regulator 84 via the communicative link 202. As such, the computing system 210 may be configured to control the operation of the regulator 84 such that the quantity of the electric power conveyed to the electric construction vehicle(s) 10 is adjusted. Moreover, the computing system 210 may be communicatively coupled to the switching assembly 86 via the communicative link 202. As such, the computing system 210 may be configured to control the operation of the switching assembly 86 such that the first electric construction vehicle 10A and/or the second electric construction vehicle 10B is charged. Additionally, the computing system 210 may be communicatively coupled to any other suitable components of the electric construction vehicle(s) 10, the docking station 106, and/or the system 200.

In general, the computing system 210 may comprise any suitable processor-based device known in the art, such as a given controller or computing device or any suitable combination of controllers or computing devices. Thus, in several embodiments, the computing system 210 may include one or more processor(s) 212 and associated memory device(s) 214 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 214 of the computing system 210 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 214 may generally be configured to store suitable computer-readable instructions that, when implemented by the processor(s) 212, configure the computing system 210 to perform various computer-implemented functions, such as one or more aspects of the methods and algorithms that will be described herein. In addition, the computing system 210 may also include various other suitable components, such as a communications circuit or module, one or more input/output channels, a data/control bus and/or the like.

It should be appreciated that the computing system 210 may correspond to an existing computing system(s) of the docking station 106, itself, or the computing system 210 may correspond to a separate processing device. For instance, in one embodiment, the computing system 210 may form all or part of a separate plug-in module that may be installed in association with the docking station 106 to allow for the disclosed systems to be implemented without requiring additional software to be uploaded onto existing control devices of the docking station 106.

Furthermore, it should also be appreciated that the functions of the computing system 210 may be performed by a single processor-based device or may be distributed across any number of processor-based devices, in which instance such devices may be considered to form part of the computing system 210. For instance, the functions of the computing system 210 may be distributed across multiple application-specific controllers or computing devices, such as a navigation controller, an engine computing controller, a transmission controller, an implement controller and/or the like.

In addition, the system 200 may also include a user interface 220. More specifically, the user interface 220 may be configured to receive inputs (e.g., inputs associated with the construction operation) from the operator. As such, the user interface 220 may include one or more input devices, such as touchscreens, keypads, touchpads, knobs, buttons, sliders, switches, mice, microphones, and/or the like, which are configured to receive inputs from the operator. Such inputs may be used by the computing system 210 for use in creating the charging schedule for the electric construction vehicles 10. Moreover, in some embodiments, the user interface 220 may include one or more feedback devices (not shown), such as display screens, speakers, warning lights, and/or the like, which are configured to provide feedback from the computing system 210 (e.g., feedback associated with the current charged level of the electric construction vehicles 10 and/or the quantity of electric power received from the power source(s)) to the operator. As such, the user interface 220 may, in turn, be communicatively coupled to the computing system 210 via the communicative link 202 to permit the feedback to be transmitted from the computing system 210 to the user interface 220. In one embodiment, the user interface 220 may be mounted or otherwise positioned on the docking station housing 36. However, in alternative embodiments, the user interface 220 may mounted at any other suitable location, such as a location remote from the docking station 106. For example, the user interface 220 may be positioned within a field house, office, or within the electric construction vehicle 10.

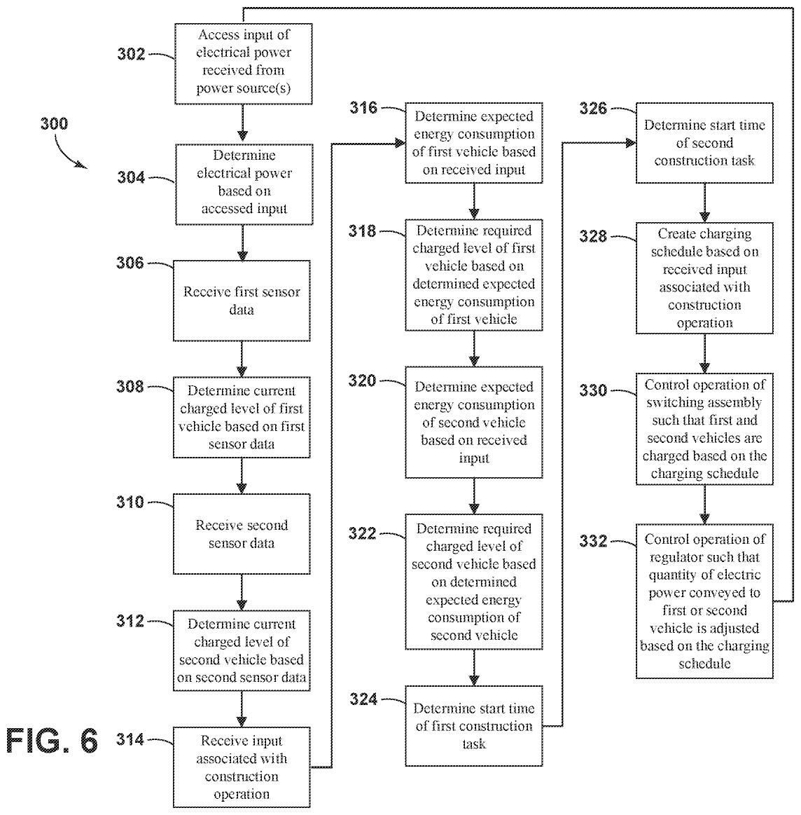

Referring now to FIG. 6, a flow diagram of one embodiment of example control logic 300 that may be executed by the computing system 210 (or any other suitable computing system) for charging electric construction vehicles is illustrated in accordance with aspects of the present subject matter. Specifically, the control logic 300 shown in FIG. 6 is representative of steps of one embodiment of an algorithm that can be executed to charge electric construction vehicles in a manner that allows for a single power source to charge multiple electric construction vehicles based the construction operation, such as the priority of the vehicles, tasks to be performed by the vehicles, and/or the like. Thus, in several embodiments, the control logic 300 may be advantageously utilized in association with a docking station for charging electric construction vehicles to allow for real-time control of electric construction vehicle charging without requiring substantial computing resources and/or processing time. However, in other embodiments, the control logic 300 may be used in association with any other suitable system, application, and/or the like for charging electric construction vehicles.

As shown in FIG. 6, at (302), the control logic 300 includes accessing an input indicative of a quantity of electrical power received from the power source. Specifically, as mentioned above, in several embodiments, the computing system 210 may be communicatively coupled to the power source sensor(s) 150 via the communicative link 202. In this respect, the computing system 210 may receive data from the power source sensor(s) 150 indicative of the electrical power received from the power source(s), such as the generator 56 and/or the distribution power grid 38. Additionally, or alternatively, the computing system 210 may receive one or more inputs from an operator via the user interface 220 indicative of the quantity of the electrical power received from the power source(s).

Additionally, at (304), the control logic 300 includes determining the quantity of the electrical power received from the power source based on the accessed input. Specifically, in several embodiments, the computing system 210 may be configured to analyze the input accessed at (302) to determine the quantity of the electrical power received from the power source(s). For example, the computing system 210 may access a look-up table(s) stored within its memory device(s) 214 that correlates the power source sensor data and/or the operator input accessed at (302) to the quantity of electrical power received from the power source(s).

Moreover, at (306), the control logic 300 includes receiving first charging capacity sensor data indicative of a current charged level of the first electric construction vehicle. Specifically, as mentioned above, in several embodiments, the computing system 210 may be communicatively coupled to the first charging capacity sensor 140A via the communicative link 202. In this respect, the computing system 210 may receive data from the first charging capacity sensor 140A indicative of the current charged level of the energy storage device(s) 104 of the first electric construction vehicle 10A.

Additionally, at (308), the control logic 300 includes determining the current charged level of the first electric construction vehicle based on the data generated by the first charging capacity sensor. Specifically, in several embodiments, the computing system 210 may be configured to analyze the first charging capacity sensor data received at (306) to determine the current charged level of the first electric construction vehicle 10A. For example, the computing system 210 may access a look-up table(s) stored within its memory device(s) 214 that correlates the first charging capacity sensor data received at (306) to the current charged level of the energy storage device(s) 104 of the first electric construction vehicle 10A.

Moreover, at (310), the control logic 300 includes receiving second charging capacity sensor data indicative of a current charged level of the second electric construction vehicle. Specifically, as mentioned above, in several embodiments, the computing system 210 may be communicatively coupled to the second charging capacity sensor 140B via the communicative link 202. In this respect, the computing system 210 may receive data from the second charging capacity sensor 140B indicative of the current charged level of the energy storage device(s) 104 of the second electric construction vehicle 10B.

In addition, at (312), the control logic 300 includes determining the current charged level of the second electric construction vehicle based on the data generated by the second charging capacity sensor. Specifically, in several embodiments, the computing system 210 may be configured to analyze the second charging capacity sensor data received at (310) to determine the current charged level of the energy storage device(s) 104 of the second electric construction vehicle 10B. For example, the computing system 210 may access a look-up table(s) stored within its memory device(s) 214 that correlates the second charging capacity sensor data received at (310) to the current charged level of the energy storage device(s) 104 of the second electric construction vehicle 10B. It should be appreciated that steps (302) through (312) could be repeated for additional electric construction vehicles.

Furthermore, at (314), the control logic 300 includes receiving an input associated with a construction operation. Specifically, in several embodiments, the computing system 210 may be configured to receive the input, such as from the user interface 220, associated with the construction operation.

For example, in some embodiments, the computing system 210 may be configured to receive an input from the user interface 220 associated with a first construction task to be performed by the first electric construction vehicle 10A. Additionally, the computing system 210 may be configured to receive the input from the user interface 220 associated with the second construction task to be performed by the second electric construction vehicle 10B. Such first and second construction tasks may correspond to any suitable construction task to be performed during a construction operation, such as digging, drilling, and/or the like.

The construction operation corresponds to a project to be completed by one or more electric construction vehicles 10 that requires completion of one or more individual construction tasks in order for the operation/project to be completed. For example, the construction operation may correspond to a landscaping operation/project in which one or more electric construction vehicles 10 may uproot trees, dig trenches, move loads of dirt, and/or other kinds of individual construction tasks. The individual construction tasks must be completed in order to complete the construction operation/project.

Additionally, at (316), the control logic 300 includes determining an expected energy consumption of the first electric construction vehicle during performance of the first construction task based on the received input associated with the first construction task. Specifically, in several embodiments, the computing system 210 may be configured to analyze the input received at (314) to determine the expected energy consumption of the energy storage device(s) 104 of the first electric construction vehicle 10A during performance of the first construction task. For example, the computing system 210 may access a look-up table(s) stored within its memory device(s) 214 that correlates the input received at (314) to the expected energy consumption of the energy storage device(s) 104 of the first electric construction vehicle 10A.

Moreover, at (318), the control logic 300 includes determining a required charged level of the first electric construction vehicle based on the determined expected energy consumption of the first electric construction vehicle. Specifically, in several embodiments, the computing system 210 may be configured to determine the required charged level of the energy storage device(s) 104 of the first electric construction vehicle 10A based on the expected energy consumption of the energy storage device(s) 104 of the first electric construction vehicle 10A determined at (316). For example, the computing system 210 may access a look-up table(s) stored within its memory device(s) 214 that correlates the expected energy consumption of the energy storage device(s) 104 of the first electric construction vehicle 10A determined at (316) to the required charged level of the energy storage device(s) 104 of the first electric construction vehicle 10A.

Additionally, at (320), the control logic 300 includes determining an expected energy consumption of the second electric construction vehicle during performance of the second construction task based on the received input associated with the second construction task. Specifically, in several embodiments, the computing system 210 may be configured to analyze the input received at (314) to determine the expected energy consumption of the energy storage device(s) 104 of the second electric construction vehicle 10B during performance of the second construction task. For example, the computing system 210 may access a look-up table(s) stored within its memory device(s) 214 that correlates the input received at (314) to the expected energy consumption of the energy storage device(s) 104 of the second electric construction vehicle 10B.

Moreover, at (322), the control logic 300 includes determining a required charged level of the second electric construction vehicle based on the determined expected energy consumption of the second electric construction vehicle. Specifically, in several embodiments, the computing system 210 may be configured to determine the required charged level of the energy storage device(s) 104 of the second electric construction vehicle 10B based on the expected energy consumption of the energy storage device(s) 104 of the second electric construction vehicle 10B determined at (320). For example, the computing system 210 may access a look-up table(s) stored within its memory device(s) 214 that correlates the expected energy consumption of the energy storage device(s) 104 of the second electric construction vehicle 10B determined at (320) to the required charged level of the energy storage device(s) 104 of the second electric construction vehicle 10B.

Furthermore, at (324), the control logic 300 includes determining a start time of the first construction task. Specifically, in several embodiments, the computing system 210 may be configured to determine the start time of the first construction task. For example, the computing system 210 may be configured to receive an input, such as from the user interface 220, of the start time of the first construction task and determine the start time of the first construction task based on the received input of the start time.

Moreover, at (326), the control logic 300 includes determining a start time of the second construction task. Specifically, in several embodiments, the computing system 210 may be configured to determine the start time of the second construction task. For example, the computing system 210 may be configured to receive an input, such as from the user interface 220, of the start time of the second construction task and determine the start time of the second construction task based on the received input of the start time.

Additionally, at (328), the control logic 300 includes creating a charging schedule for which a first electric construction vehicle and a second electric construction vehicle will be charged based on the received input. Specifically, in several embodiments, the computing system 210 may be configured to create the charging schedule for which the first electric construction vehicle 10A and the second electric construction vehicle 10B will be charged based on the input of the charging operation received at (314) and/or the quantity of electrical power received from the power source(s) determined at (304). The charging schedule may include the order in which the electric construction vehicles 10 are charged, the amount of time in which the electric construction vehicles are charged, and/or the like.

For example, in several embodiments, the computing system 210 may be configured to create the charging schedule such that the first electric construction vehicle 10A and/or the second electric construction vehicle 10B are charged based on the quantity of electrical power received from the power source(s), such as the generator 56 and/or the power distribution grid 38, determined at (304). As such, the computing system 210 may create the charging schedule to prioritize the charging of the electric construction vehicles 10 according to the availability of electrical power received from the power source(s) to the docking station 106.

Additionally, or alternatively, in several embodiments, the computing system 210 may be configured to create the charging schedule such that the first electric construction vehicle 10A is charged from the current charged level determined at (308) to the required charged level determined at (318) prior to the start time of the first construction task determined at (324). In addition, the computing system 210 may be configured to create the charging schedule such that the second electric construction vehicle 10B is charged from the current charged level determined at (312) to the required charged level determined at (322) prior to the start time of the second construction task determined at (326).

Additionally, or alternatively, in several embodiments, when creating the charging schedule, the computing system 210 may be configured to determine an order in which the first electric construction vehicle 10A and the second electric construction vehicle 10B will be charged based on the start time of the first construction task determined at (324) and the start time of the second construction task determined at (326). Thereafter, the computing system 210 may be configured to create the charging schedule based on the determined order and start times of the first and second construction tasks.

Furthermore, at (330), the control logic 300 includes controlling an operation of the switching assembly such that the first electric construction vehicle and the second electric construction vehicle are charged based on the created charging schedule. Specifically, in several embodiments, the computing system 210 may be configured to control the operation of the switching assembly 86, such as by controlling the first switch 88A or the second switch 88B of the switching assembly 86, such that the energy storage device(s) 104 of the first electric construction vehicle 10A and the second electric construction vehicle 10B are charged based on the charging schedule created at (328). For example, the computing system 210 may be configured to determine the current time and compare the current time to the charging schedule created at (328) to determine which of the electric construction vehicles 10 to charge. Thereafter, the computing system 210 may control the operation of the switching assembly 86 such that electric power is conveyed to the charging port 108 of the corresponding electric construction vehicle 10 accordingly.

Moreover, at (332), the control logic 300 includes controlling an operation of the regulator such that the quantity of the electric power that is conveyed to the first electric construction vehicle or the second electric construction vehicle is adjusted based on the created charging schedule. Specifically, as mentioned previously, in several embodiments, the computing system 210 may be communicatively coupled to the regulator 84 via the communicative link 202. As such, the computing system 210 may be configured to control the operation of the regulator such that the quantity of the electric power that is conveyed to the first electric construction vehicle 10A or the second electric construction vehicle 10B is adjusted based on the charging schedule created at (328). Thereafter, the control logic 300 returns to (302).

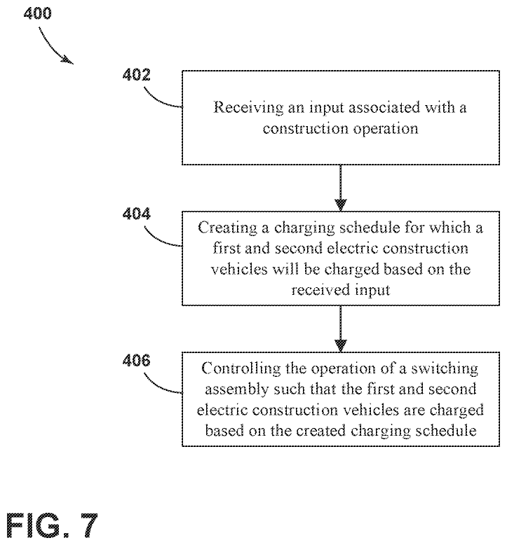

Referring now to FIG. 7, a flow diagram of one embodiment of a method 400 for electric construction vehicles is illustrated in accordance with aspects of the present subject matter. In general, the method 400 will be described herein with reference to the electric construction vehicle 10, the docking station 106, and the system 200 described above with reference to FIGS. 1-6. However, it should be appreciated by those of ordinary skill in the art that the disclosed method 400 may generally be implemented with any electric construction vehicle having any suitable vehicle configuration, any docking station 106 having any suitable docking station configuration, and/or within any system having any suitable system configuration. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 7, at (402), the method 400 includes receiving, with a computing system, an input associated with a construction operation. For instance, as described above, the computing system 210 may be configured to receive the input associated with the construction operation.

Furthermore, at (404), the method 400 includes creating, with the computing system, a charging schedule for which a first electric construction vehicle and a second electric construction vehicle will be charged based on the received input. For instance, as described above, the computing system 210 may be configured to create the charging schedule for which the first electric construction vehicle 10A and the second electric construction vehicle 10B will be charged based on the received input.

Additionally, at (406), the method 400 includes controlling, with the computing system, an operation of a switching assembly adjustable between a first setting in which electric power is conveyed to the first electric construction vehicle and a second setting in which the electric power is conveyed to the second electric construction vehicle such that the first electric construction vehicle and the second electric construction vehicle are charged based on the created charging schedule. For instance, as described above, the computing system 210 may be configured to control the operation of the switching assembly 86 such that the first electric construction vehicle 10A and the second electric construction vehicle 10B are charged based on the created charging schedule.

It is to be understood that the steps of the control logic 300 and the method 400 are performed by the computing system 210 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 210 described herein, such as the control logic 300 and the method 400, is implemented in software code or instructions which are tangibly stored on a tangible computer readable medium. The computing system 210 loads the software code or instructions via a direct interface with the computer readable medium or via a wired and/or wireless network. Upon loading and executing such software code or instructions by the computing system 210, the computing system 210 may perform any of the functionality of the computing system 210 described herein, including any steps of the control logic 300 and the method 400 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A system for charging electric construction vehicles, the system comprising:
a first connector configured to be electrically coupled to a first electric construction vehicle and convey electric power received from a power source to the first electric construction vehicle;
a second connector configured to be electrically coupled to a second electric construction vehicle and convey the electric power received from the power source to the second electric construction vehicle;
a switching assembly adjustable between a first setting in which the electric power received from the power source is conveyed to the first electric construction vehicle and a second setting in which the electric power received from the power source is conveyed to the second electric construction vehicle; and
a computing system communicatively coupled to the switching assembly, the computing system configured to:
receive an input associated with a construction operation;
create a charging schedule for which the first electric construction vehicle and the second electric construction vehicle will be charged based on the received input; and
control an operation of the switching assembly such that the first electric construction vehicle and the second electric construction vehicle are charged based on the created charging schedule.

2. The system of claim 1, further comprising:
a first charging capacity sensor communicatively coupled to the computing system and configured to generate data indicative of a current charged level of the first electric construction vehicle; and
a second charging capacity sensor communicatively coupled to the computing system and configured to generate data indicative of a current charged level of the second electric construction vehicle,
wherein, when creating the charging schedule, the computing system is configured to:
determine the current charged level of the first electric construction vehicle based on the data generated by the first charging capacity sensor;
determine the current charged level of the second electric construction vehicle based on the data generated by the second charging capacity sensor; and
create the charging schedule based on the determined current charged level of the first electric construction vehicle and the second electric construction vehicle and the received input associated with the construction operation.

3. The system of claim 2, wherein the computing system is further configured to:
when receiving the input associated with the construction operation, receive an input associated with a first construction task to be performed by the first electric construction vehicle;
determine an expected energy consumption of the first electric construction vehicle during performance of the first construction task based on the received input associated with the first construction task;
determine a required charged level of the first electric construction vehicle based on the determined expected energy consumption of the first electric construction vehicle;
when receiving the input associated with the construction operation, receive an input associated with a second construction task to be performed by the second electric construction vehicle;
determine an expected energy consumption of the second electric construction vehicle during performance of the second construction task based on the received input associated with the second construction task; and
determine a required charged level of the second electric construction vehicle based on the determined expected energy consumption of the second electric construction vehicle.

4. The system of claim 3, wherein, when creating the charging schedule, the computing system is further configured to:
determine a start time of the first construction task;
determine a start time of the second construction task; and
create the charging schedule such that the first electric construction vehicle is charged from the current charged level of the first electric construction vehicle to the required charged level of the first electric construction vehicle prior to the start time of the first construction task and the second electric construction vehicle is charged from the current charged level of the second electric construction vehicle to the required charged level of the second electric construction vehicle prior to the start time of the second construction task.

5. The system of claim 4, wherein, when creating the charging schedule, the computing system is further configured to:
determine an order in which the first electric construction vehicle and the second electric construction vehicle will be charged based on the determined start time of the first construction task and the determined start time of the second construction task; and
create the charging schedule based on the determined order.

6. The system of claim 1, further comprising:
a regulator communicatively coupled to the computing system and configured to adjust a quantity of the electric power that is conveyed to the first electric construction vehicle or the second electric construction vehicle, and
wherein, the computing system is configured to:
control an operation of the regulator such that the quantity of the electric power that is conveyed to the first electric construction vehicle or the second electric construction vehicle is adjusted based on the created charging schedule.

7. The system of claim 1, wherein the power source is at least one of an electric power grid or a generator.

8. The system of claim 1, wherein the computing system is configured to:
receive an input associated with a quantity of the electric power received from the power source; and
create the charging schedule based on the received input associated with the quantity of the electric power received from the power source.

9. A method for charging electric construction vehicles, the method comprising:
receiving, with a computing system, an input associated with a construction operation;
creating, with the computing system, a charging schedule for which a first electric construction vehicle and a second electric construction vehicle will be charged based on the received input; and
controlling, with the computing system, an operation of a switching assembly adjustable between a first setting in which electric power is conveyed to the first electric construction vehicle and a second setting in which the electric power is conveyed to the second electric construction vehicle such that the first electric construction vehicle and the second electric construction vehicle are charged based on the created charging schedule.

10. The method of claim 9, wherein, when creating the charging schedule, the method comprises:
receiving, with the computing system, first charging capacity sensor data indicative of a current charged level of the first electric construction vehicle;
determining, with the computing system, the current charged level of the first electric construction vehicle based on the received first charging capacity sensor data;
receiving, with the computing system, second charging capacity sensor data indicative of a current charged level of the second electric construction vehicle;
determining, with the computing system, the current charged level of the second electric construction vehicle based on the received second charging capacity sensor data; and
creating, with the computing system, the charging schedule based on the determined current charged level of the first electric construction vehicle and the second electric construction vehicle and the received input associated with the construction operation.

11. The method of claim 10, further comprising:
when receiving the input associated with the construction operation, receiving, with the computing system, an input associated with a first construction task to be performed by the first electric construction vehicle;
determining, with the computing system, an expected energy consumption of the first electric construction vehicle during performance of the first construction task based on the received input associated with the first construction task;
determining, with the computing system, a required charged level of the first electric construction vehicle based on the determined expected energy consumption of the first electric construction vehicle;
when receiving the input associated with the construction operation, receiving, with the computing system, an input associated with a second construction task to be performed by the second electric construction vehicle;
determining, with the computing system, an expected energy consumption of the second electric construction vehicle during performance of the second construction task based on the received input associated with the second construction task; and
determining, with the computing system, a required charged level of the second electric construction vehicle based on the determined expected energy consumption of the second electric construction vehicle.

12. The method of claim 11, wherein, when creating the charging schedule, the method further comprises:
determining, with the computing system, a start time of the first construction task;
determining, with the computing system, a start time of the second construction task; and
creating, with the computing system, the charging schedule such that the first electric construction vehicle is charged from the current charged level of the first electric construction vehicle to the required charged level of the first electric construction vehicle prior to the start time of the first construction task and the second electric construction vehicle is charged from the current charged level of the second electric construction vehicle to the required charged level of the second electric construction vehicle prior to the start time of the second construction task.

13. The method of claim 12, wherein, when creating the charging schedule, the method comprises:
determining, with the computing system, an order in which the first electric construction vehicle and the second electric construction vehicle will be charged based on the start time of the first construction task and the start time of the second construction task; and
creating, with the computing system, the charging schedule based on the determined order.

14. The method of claim 9, further comprising:
controlling, with the computing system, an operation of a regulator configured to adjust a quantity of the electric power that is conveyed to the first electric construction vehicle or the second electric construction vehicle such that the quantity of electric power that is conveyed to the first electric construction vehicle or the second electric construction vehicle is adjusted based on the created charging schedule.

15. A docking station for charging electric construction vehicles, comprising:
a first charging conduit configured to be electrically coupled to a first electric construction vehicle and convey electric power received from a power source to the first electric construction vehicle;
a second charging conduit configured to be electrically coupled to a second electric construction vehicle and convey the electric power received from the power source to the second electric construction vehicle;
a first connector configured to electrically couple the first charging conduit to the first electric construction vehicle;
a second connector configured to electrically couple the second charging conduit to the second electric construction vehicle;
a switching assembly adjustable between a first setting in which the electric power received from the power source is conveyed to the first electric construction vehicle and a second setting in which the electric power received from the power source is conveyed to the second electric construction vehicle; and
a computing system communicatively coupled to the switching assembly, the computing system configured to:
receive an input associated with a construction operation;
create a charging schedule for which the first electric construction vehicle and the second electric construction vehicle will be charged based on the received input; and
control an operation of the switching assembly such that the first electric construction vehicle and the second electric construction vehicle are charged based on the created charging schedule.

16. The docking station of claim 15, wherein:
a first charging capacity sensor is communicatively coupled to the computing system and configured to generate data indicative of a current charged level of the first electric construction vehicle,
a second charging capacity sensor is communicatively coupled to the computing system and configured to generate data indicative of a current charged level of the second electric construction vehicle, and
when creating the charging schedule, the computing system is configured to:
determine the current charged level of the first electric construction vehicle based on the data generated by the first charging capacity sensor;
determine the current charged level of the second electric construction vehicle based on the data generated by the second charging capacity sensor; and
create the charging schedule based on the determined current charged level of the first electric construction vehicle and the second electric construction vehicle and the received input associated with the construction operation.

17. The docking station of claim 16, wherein the computing system is further configured to:
when receiving the input associated with the construction operation, receive an input associated with a first construction task to be performed by the first electric construction vehicle;
determine an expected energy consumption of the first electric construction vehicle during performance of the first construction task based on the received input associated with the first construction task;
determine a required charged level of the first electric construction vehicle based on the determined expected energy consumption of the first electric construction vehicle;
when receiving the input associated with the construction operation, receive an input associated with a second construction task to be performed by the second electric construction vehicle;
determine an expected energy consumption of the second electric construction vehicle during performance of the second construction task based on the received input associated with the second construction task; and
determine a required charged level of the second electric construction vehicle based on the determined expected energy consumption of the second electric construction vehicle.

18. The docking station of claim 17, wherein, when creating the charging schedule, the computing system is further configured to:
determine a start time of the first construction task;
determine a start time of the second construction task; and
create the charging schedule such that the first electric construction vehicle is charged from the current charged level of the first electric construction vehicle to the required charged level of the first electric construction vehicle prior to the start time of the first construction task and the second electric construction vehicle is charged from the current charged level of the second electric construction vehicle to the required charged level of the second electric construction vehicle prior to the start time of the second construction task.

19. The docking station of claim 18, wherein, when creating the charging schedule, the computing system is configured to:
determine an order in which the first electric construction vehicle and the second electric construction vehicle will be charged based on the determined start time of the first construction task and the determined start time of the second construction task; and
create the charging schedule based on the determined order.

20. The docking station of claim 15, wherein the computing system is configured to:
receive an input associated with a quantity of the electric power received from the power source; and
create the charging schedule based on the received input associated with the quantity of the electric power received from the power source.
